(19) United States
(12) Patent Application Publication
(10) Pub. No.: US 2018/0333323 A1
(43) Pub. Date: Nov. 22, 2018

(54) Hand Held Soft Tissue Instrument

(71) Applicant: Carl R. Hanson, Medford, OR (US)

(72) Inventor: Carl R. Hanson, Medford, OR (US)

(21) Appl. No.: 15/600,688

(22) Filed: May 19, 2017

(51) Int. Cl. A61H 7/00

(52) U.S. Cl. CPC A61H 7/003; A61H 2205/065; A61H 2201/0157; A61H 7/002; A61H 2201/0153; A61H 2205/067

(57) ABSTRACT

A soft tissue manipulation instrument for use by a practitioner on the soft tissue of a living being having an elongated body with soft edges, a front surface, a rear surface, sides, a tapered end and a curved, concave end opposite the tapered end. The front surface has a plurality of finger engaging recesses; at least one recess located adjacent the tapered end and at least a second recess located adjacent the curved end. The rear surface includes an elongated finger engaging slot disposed in a longitudinal direction between the tapered end and the curved end.

### BACKGROUND OF THE INVENTION

The present invention relates to hand held, body working tools and in particular to a soft tissue manipulation instrument.

### DESCRIPTION OF THE PRIOR ART

The human body often breaks down after excessive work, exercise or overuse or from an injury. When this occurs, the sot tissue of the human body such as muscles, tendons, ligaments and fascia is restricted or degenerated. As these areas heal, often fibrous adhesions or scar tissue are developed that further decreases the flexibility and mobility of the body part affected. A number of soft tissue manipulation tools have been developed for use by therapists and body work practitioners to promote healing of the injured areas. These instrument assisted, soft tissue mobilization tools are used by a variety of healthcare practitioners, occupational therapists, chiropractors and massage therapists to treat areas of soft tissue restrictions and degeneration.

A prior art body working tool is shown in U.S. Pat. No. 6,077,239 to Lin directed to a robbing plate having a rear projecting portion and a curved recessed portion in addition to a plurality of raised massage portion on one wall thereof.

Another tool of interest is shown in U.S. Pat. No. 5,366,437 to Graston that relates to soft tissue tool having a tissue engagement portion in combination with an integral handle portion.

Other patents of interest are D 696,414 to Hayami, D 686,333 to Innes, D 678,539 to Narson, D 645,568 to Walker, D 638,549 and D 634,022 to Scappaticci and Application Number 2015/0265486 to Flore.

### SUMMARY OF THE INVENTION

The present invention is a simple, easy to use instrument assisted soft tissue mobilization and manipulation instrument particularly for use on the soft tissue of a human hand or finger. The instrument is used to break down fascial restrictions and adhesions and scar tissue allowing for the return of normal movement of my muscles, ligaments, tendons and/or joints particularly in these small or hard to reach areas of the human body. The techniques available when using the instrument of the present invention promote healing by increasing blood flow to the affected areas that, in turn, promotes an increase of nutrients flowing into and waste material flowing out of the degenerated tissue.

The instrument is formed of an elongated body having a front surface, a rear surface, parallel sides, a tapered end and a curved arcuate concave end opposite the tapered end. The front surface of the instrument has a plurality of rounded finger engaging recesses; at least one recess being located adjacent the tapered end and at least a second recess located adjacent the curved arcuate concave end. The rear surface includes an elongated, finger engaging slot disposed in a longitudinal direction between the tapered end and the curved end.

The instrument is perfect for releasing soft tissue adhesions and fascia of the wrist, hand and fingers. It is light weight and has a relatively small size that allows the practitioner to assess and quickly release the tiny, delicate soft tissues of the hand. The instrument when properly used can enhance the practitioner's ability to detect soft tissue restrictions that might be otherwise missed.

In use a practitioner chooses either the tapered end, for example, when working with a specific energy point or the curved end when working with a more rounded surface such as a human finger, toe or the like. The instrument is placed against the area being treated while the practitioner holds the instrument in the fingers. Preferably one of the practitioner's finger tips is placed in one of the round, cup-shaped shallow depressions closest to the working end of the instrument being used. This stabilizes the practitioner's hold on the instrument allowing the instrument to be used with an appropriate amount of force against the soft tissue being treated without slippage or the requirement of excessive gripping pressure to hold the instrument that could be disruptive to the treatment. In addition, the practitioner is able to engage the elongated slot at the rear surface of the instrument to further stabilize the grip on the instrument and eliminates the need for excessive grip pressure.

Among the objects of the present invention is the provision of a soft tissue mobilization instrument for use by a health care practitioner to manipulate and mobilize the soft tissue of an individual.

Another object is the provision of a soft tissue mobilization instrument designed for use on the hand and finger areas of an individual.

Still another object the provision of a soft tissue mobilization instrument that can be effective held and used by a practitioner working on the hand area of an individual.

These and other objects will become apparent with reference to the following detailed description and accompanying drawings of the instrument of the present invention.

### DESCRIPTION OF THE DRAWINGS

FIG. 1 illustrates a front perspective view of the instrument of the present invention.

FIG. 2 illustrates a rear perspective view of the instrument of FIG. 1.

FIG. 3 illustrates a top plan view of the front of the instrument.

FIG. 4 illustrates a side elevational view of the instrument.

FIG. 5 illustrates a top plan view of the rear of the instrument.

FIG. 6 illustrates a view of the tapered end of the instrument being used to treat a human palm of a hand.

FIG. 7 illustrates a view of the arcuate end of the instrument being used to treat a finger of a human hand.

FIG. 8 Illustrates another view of the arcuate end of the instrument being used to treat a finger of a human hand.

### DESCRIPTION OF A PREFERRED EMBODIMENT

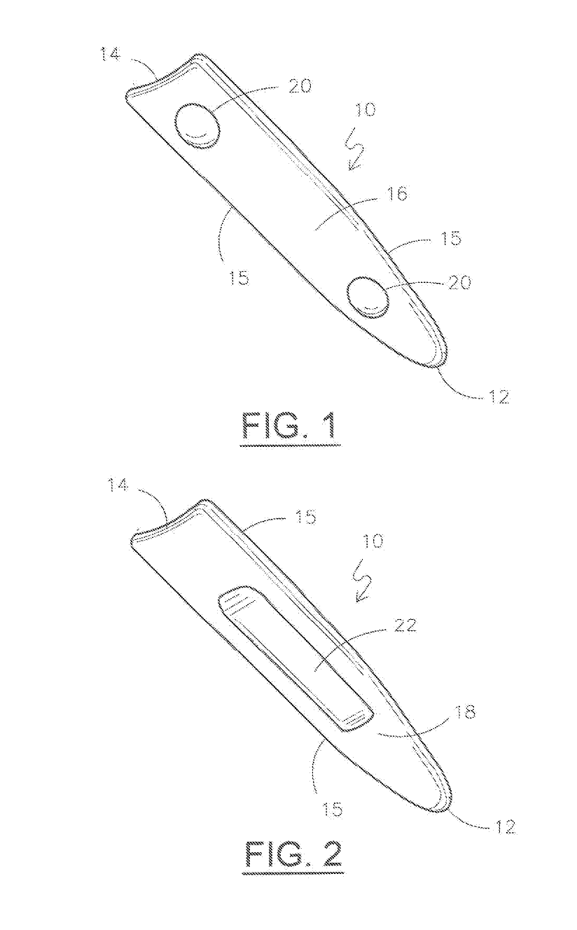

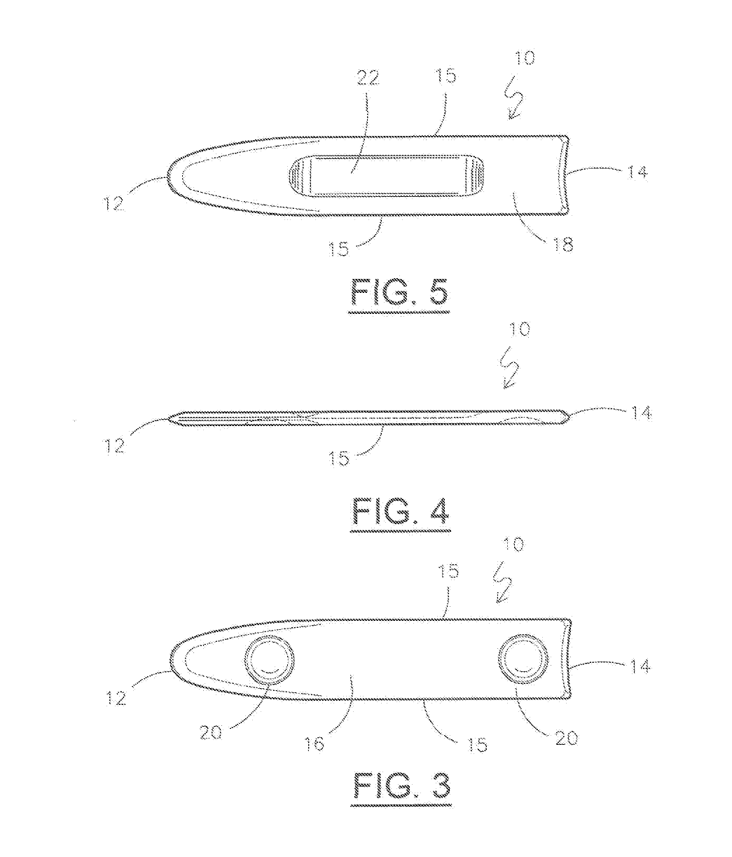

Referring to the drawings, FIGS. 1 to 5 illustrate a soft tissue manipulation instrument 10 of the present invention. The instrument 10 is preferably made of stainless steel or a similar metal, although it will be appreciated the instrument 10 can be made of other material such as wood or plastic. The instrument 10 is generally elongated in shape with a length of approximately 4 to 6 inches long and is relatively thin as illustrated in FIG. 4. The instrument 10 includes a smooth, elongated body portion 11, a tapered end 12 and a curved or arcuate end 14 at the opposite end from the tapered end 12 and parallel sides 15 between the tapered end 12 and the curved end 14. Preferably the curved end 14 of the instrument 10 is concave although other shapes are contemplated for use on specific shapes of the human body. A front surface 16 is formed with a pair of round, cup shaped, shallow finger-tip accommodating depressions 20. A rear surface 18 is formed with an elongated slot 22 formed into the rear surface 18 that also serves a thumb or finger guide or locator when the instrument 10 is used in a treatment.

The peripheral edges of the instrument 10 including the tapered end 12, the parallel sides 15 and the curved end 14 are rounded with a radius that allows smooth and continuous movement of the instrument 10 across the soft tissue of a person undergoing treatment without excessive bruising or degradation of the outer skin at the area being treated.

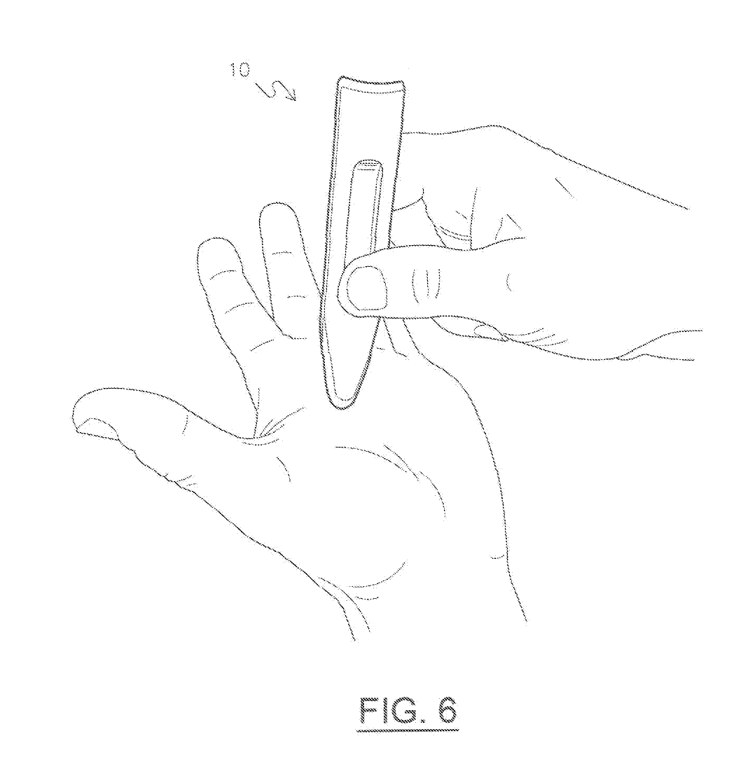

FIGS. 6, 7 and 8 illustrate various use of the instrument 10 to treat the human hand.

FIG. 6 shows the instrument 10 being held by a practitioner to treat the palm of a human hand with the tapered end 12 of the Instrument 10. It can be seen the thumb of the practitioner engages the elongated slot 22 formed in the rear surface 18 of the instrument 10.

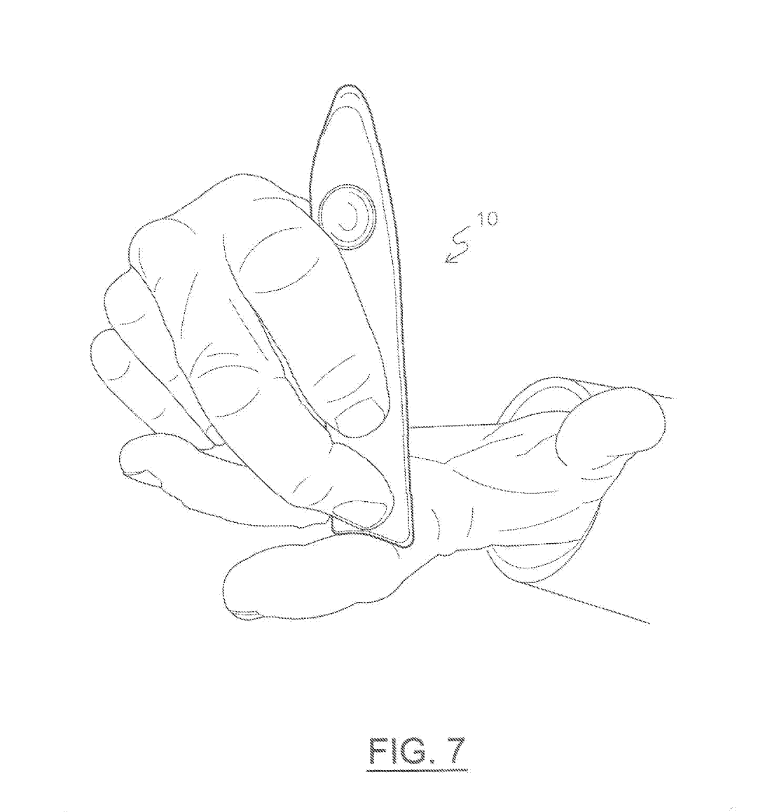

FIG. 7 shows the instrument 10 from a frontal view being used by a practitioner to treat a finger of a human hand using the lower concave, arcuate end 14 of the instrument 10. In this view, the middle finger of the practitioner engages a finger accommodating depression 20 that is closest to the arcuate end 14 to stabilize the instrument when in use and to facilitate moving the instrument 10 across the soft tissue of the hand.

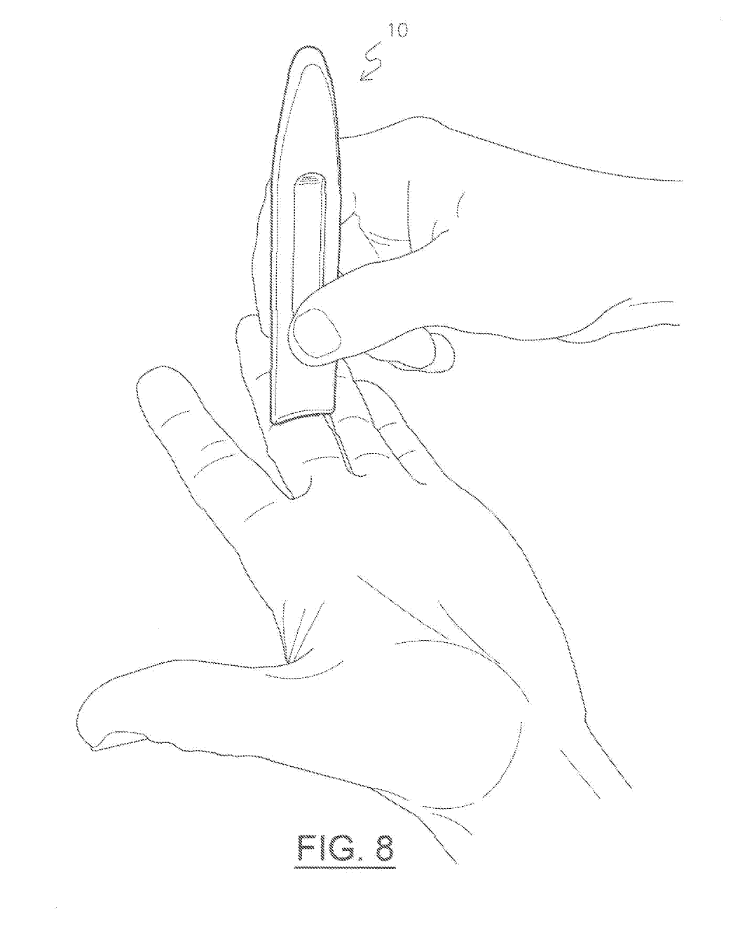

FIG. 8 shows the instrument 10 from a rear view being used by a practitioner to treat a human finger with the arcuate end 14 of the instrument 10. As with the view shown in FIG. 6, the thumb of the practitioner engages the elongated slot 22 formed in the rear surface 18 during use to stabilize the instrument 10 and facilitate movement thereof during the treatment process.

It will be appreciated these figures are illustrative only and the fingers and thumb of a practitioner may engage the described recesses 20 on the front of the instrument 10 and/or the rear elongated slot 22 on the rear of the instrument 10 in whatever manner that facilitates the selected treatment.

In addition, the instrument 10 may be used to treat any other human or even animal body pads while keeping within the spirit and scope of the present Invention as defined in the accompanying claims.

1. A manipulation instrument for use by a practitioner on the soft tissue of a living being comprising:
an elongated body having edges and a front surface, a rear surface, sides, a tapered end and a curved end opposite said tapered end;
said instrument characterized by said front surface having a plurality of finger engaging recesses; at least one recess located adjacent said tapered end and at least a second recess located adjacent said curved end; and said rear surface having an elongated finger engaging slot disposed in a longitudinal direction between said tapered end and said curved end.

2. The instrument of claim 1 wherein said curved end is further defined as having a concave arcuate shape.

3. The instrument of claim 1 wherein said sides are parallel each to the other.

4. The instrument of claim 1 wherein said edges are rounded.

5. The instrument of claim 1 wherein said finger engaging recesses have round, cup shaped, shallow depressions.

6. A manipulation instrument for use by a practitioner on the soft tissue of a living being comprising:
an elongated body having rounded peripheral edges and a front surface, a rear surface, parallel sides, a tapered end and a concave shaped curved end opposite said tapered end;
said instrument characterized by said front surface having a plurality of finger engaging recesses; said finger engaging recesses formed as round, cup shaped, shallow depressions;
at least one of said recesses being located adjacent said tapered end and at least a second of said recesses being located adjacent said curved end; and said rear surface having an elongated finger engaging slot disposed in a longitudinal direction between said tapered end and said curved end.
